(19) United States
(12) Patent Application Publication
(10) Pub. No.: US 2017/0038514 A1
(43) Pub. Date: Feb. 9, 2017

(54) LIGHT SOURCE APPARATUS AND ENDOSCOPE APPARATUS WITH THE LIGHT SOURCE APPARATUS

(71) Applicant: OLYMPUS CORPORATION, Tokyo (JP)

(72) Inventors: Masahiro NISHIO, Hachioji-shi (JP); Takeshi ITO, Hino-shi (JP); Motoki TABATA, Hino-shi (JP)

(73) Assignee: OLYMPUS CORPORATION, Tokyo (JP)

(21) Appl. No.: 15/332,237

(22) Filed: Oct. 24, 2016

Related U.S. Application Data
(63) Continuation of application No. PCT/JP2015/061485, filed on Apr. 14, 2015.

(30) Foreign Application Priority Data
Apr. 25, 2014 (JP) 2014-091816

(51) Int. Cl. F21V 8/00; G02B 23/24; F21V 33/00; G01J 1/04; F21V 9/16; F21V 7/00

(52) U.S. Cl. CPC G02B 6/0008; F21V 9/16; F21V 7/00; F21V 33/0068; G01J 1/0414; G02B 23/2469; F21W 2131/20

(57) ABSTRACT

A light source apparatus includes an optical fiber that guides light source light emitted from a light source, and a light detection section that detects a quantity of the light source light guided by the optical fiber. The light detection section includes a light detector that outputs a signal indicating a quantity of incoming light, a light extraction section that is provided at a part of the optical fiber and extracts a part of light source light guided by the optical fiber as detected light, and a detected light optimization section that changes the detected light extracted from the optical fiber by the light extraction section into light having a light characteristic appropriate for detection of a quantity of light by the light detector.

### CROSS-REFERENCE TO RELATED APPLICATIONS

This application is a Continuation Application of PCT Application No. PCT/JP2015/061485, filed Apr. 14, 2015 and based upon and claiming the benefit of priority from Japanese Patent Application No. 2014-091816, filed Apr. 25, 2014, the entire contents of which are incorporated herein by reference.

### BACKGROUND OF THE INVENTION

1. Field of the Invention

The present invention relates to a light source apparatus.

2. Description of the Related Art

Jpn. Pat. Appln. KOKAI Publication No. 2004-087915 discloses a light source apparatus using an optical fiber. A technique of automatically controlling the output of light emitted from a semiconductor light-emitting element by detecting a leaked light from a leaking light generation section provided in an optical fiber in the apparatus is proposed.

Specifically, the light source apparatus has the following structure. A step-index type optical fiber including a core and a cladding has an exposed portion of the core where a portion of the cladding is removed. The exposed portion of the core is provided with an irregular surface to scatter light. A photodiode is arranged in the proximity of the exposed portion of the core to detect scattered light leaking out from the exposed portion.

### BRIEF SUMMARY OF THE INVENTION

A light source apparatus according to the present invention comprises at least one light source, at least one optical fiber that guides light source light emitted from the light source, and a light detection section that detects a quantity of the light source light guided by the optical fiber. The light detection section comprises a light detector that outputs a signal indicating a quantity of incoming light, a light extraction section that is provided at a part of the optical fiber and extracts a part of light source light guided by the optical fiber as detected light, and a detected light optimization section that changes the detected light extracted from the optical fiber by the light extraction section into light having a light characteristic appropriate for detection of a quantity of light by the light detector.

Advantages of the invention will be set forth in the description that follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute apart of the specification, illustrate embodiments of the invention, and together with the general description given above and the detailed description of the embodiments given below, serve to explain the principles of the invention.

FIG. 1 shows the structure of the light source apparatus according to Embodiment 1.

FIG. 2 is a block diagram of the light detection section shown in FIG. 1.

FIG. 3 shows the structure of the light detection section shown in FIG. 1.

FIG. 4 shows the structure of the light source apparatus according to Embodiment 2.

FIG. 5 shows the structure of the light detection section shown in FIG. 4.

FIG. 6 shows an example lighting pattern of the light source at the light source apparatus shown in FIG. 4.

FIG. 7 shows a situation of the fixation of the light detection section shown in FIG. 4.

FIG. 8 schematically shows an endoscope apparatus in which the light source apparatus is mounted.

FIG. 9 shows another structure example of the light detection section of FIG. 4 in the modification 1 of Embodiment 2.

FIG. 10 shows spectrums of light source light and fluorescent light in the modification 2 in Embodiment 2.

FIG. 11 shows a wavelength sensitivity characteristic of the PD in the modification 2 in Embodiment 2.

FIG. 12 shows the structure of the light source apparatus of Embodiment 3.

FIG. 13 shows the structure of the light detection section shown in FIG. 12.

### DETAILED DESCRIPTION OF THE INVENTION

### Embodiment 1

### <Structure>

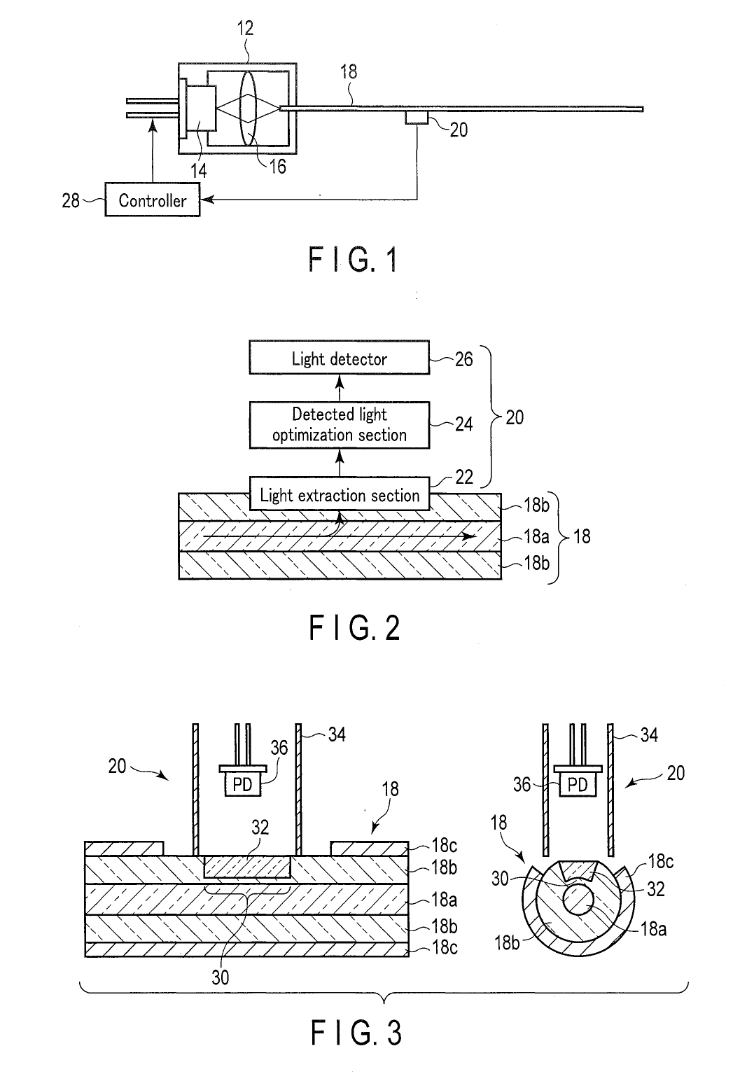

As shown in FIG. 1, the light source apparatus of the present embodiment comprises a light source 12, an optical fiber 18 that guides light source light emitted from the light source 12, and a light detection section 20 that detects a quantity of the light source light guided by the optical fiber 18.

The light source 12 includes a light emitting element 14 that emits light, and a lens 16 that couples light source light emitted from the light emitting element 14 to the optical fiber 18.

The light source apparatus also includes a controller 28 that controls the light emitting element 14 based on a detection signal output from the light detection section 20. In order to control the light emitting element 14, the controller 28 includes an electric circuit that operates the detection signal, and the electric circuit includes a processor (including hardware) that calculates the detection signal.

### <Semiconductor Laser (LD)>

The light emitting element 14 may comprise, for example, a semiconductor laser. A semiconductor laser is a solid light source apparatus that includes a semiconductor through which electricity is sent to emit laser light, and a variety of semiconductor lasers having various wavelengths, from ultraviolet light to infrared light, have become commercially practical. A semiconductor laser has advantages, such as small size and lower power consumption, and in recent years, semiconductor lasers with a high luminance and semiconductor lasers that oscillate at a novel wavelength have been widely developed. Generally, laser light is emitted at a line spectrum of a narrow wavelength. The width of a spectrum line is normally less than a few nm for a semiconductor laser. Semiconductor lasers include an edge light-emitting type semiconductor laser (a stripe laser) that emits light from the cleavage plane of a wafer, a plane light-emitting type semiconductor laser that emits light from the surface of a wafer (a vertical-oscillator type vertical cavity surface emitting laser), and the like. Furthermore, a hybrid semiconductor laser has been commercially practical, which is represented by a second harmonic type semiconductor laser (SHG semiconductor laser) that makes an oscillation wavelength of the semiconductor laser half by combining a nonlinear crystal with the emission section of the semiconductor laser.

For the light emitting element 14, a device that emits non-interferential light, represented by an LED, may be used.

### <Optical Fiber>

In the present embodiment, the optical fiber 18 is used to guide light source light from the light source 12. Various optical fibers in practical use can be used as the optical fiber 18. In the present embodiment, a multi-mode laser is used as the light emitting element 14; thus, a multi-mode type optical fiber is used to effectively take into and guide light from the multi-mode laser. The multi-mode type optical fiber 18 may comprise, for example, a step index (SI) fiber having a core 18a and a cladding 18b as shown in FIG. 2, which generally has a core diameter from several tens of micrometers to 200 micrometers. The refractive index of the core 18a of the optical fiber 18 is set higher than the refractive index of the cladding 18b. A core diameter of the optical fiber 18 is preferably thick from the viewpoint of improving the incoming light rate of light source light emitted from the light emitting element 14, on the other hand it is preferably small for flexibility and diameter reduction. For this reason, it can be selected based on the light emitting element 14 to be used, an optical structure of the part connecting the light emitting element 14 with the optical fiber 18, the thickness of an apparatus into which the optical fiber 18 is incorporated, such as the insertion section of an endoscope, input/output conditions of an optical coupler that is described later, and the like. In the present embodiment, an optical fiber having a core diameter of 50 μm and a cladding diameter of 125 μm is used as the optical fiber 18 that is mounted in the insertion section of the endoscope, and guides light source light to a light emitting section. The optical fiber 18 is not limited to those mentioned herein; it maybe a single-mode fiber. The optical fiber 18 may be a grated index (GI) fiber.

### <Light Detection Section>

A block diagram of the light detection section 20 is shown in FIG. 2. As shown in FIG. 2, the light detection section 20 comprises a light detector 26 that outputs a signal indicating a quantity of incoming light, a light extraction section 22 that is provided at a part of the optical fiber 18 and extracts a part of light source light guided by the optical fiber 18 as detected light, and a detected light optimization section 24 that changes the detected light extracted from the optical fiber 18 by the light extraction section 22 into light having an optical characteristic appropriate for the detection of a quantity of light by the light detector 26.

To detect a quantity of light by the light detector 26, the light extraction section 22 provided at the optical fiber 18 separates a part of light source light guided by the optical fiber 18 as detected light and passes it to the detected light optimization section 24 so that an appropriate quantity of detected light enters the light detector 26. The detected light optimization section 24 causes the detected light received from the light extraction section 22 to enter the light detector 26. At this time, the optical characteristic of the detected light is changed so as to facilitate the detection by the light detector 26, in other words, so as to effectively detect light. The detected light that has exit from the detected light optimization section 24 enters the light detector 26 and is converted into an electrical signal, etc. to become a detection signal.

A specific structure of the light detection section 20 is shown in FIG. 3. As shown in FIG. 3, the optical fiber 18 is provided with a jacket (coating) 18c around the cladding 18b. The jacket 18c serves to enhance the strength of the optical fiber 18. An opening is formed at a part of the jacket 18c to partially expose the cladding 18b. A light extraction region 30 as the light extraction section 22 is formed at the exposed portion of the cladding 18b. The light extraction region 30 comprises a region where the thickness of the cladding 18b is locally reduced. A diffusion member 32 is provided at the concave part formed by forming the light extraction region 30.

A photodiode (PD) 36 serving as the light detector 26 is disposed above and in the radial direction of the optical fiber 18 with respect to the diffusion member 32. The PD 36 is disposed and supported so as to face the diffusion member 32.

The light extraction region 30 spreads over a predetermined angle range at a cross section perpendicular to the axis of the optical fiber 18. The thickness of the cladding 18b in the light extraction region 30 is adjusted so as to allow a minimum quantity of detected light required for detection of a quantity of light performed by the PD 36 to leak out. For this reason, the thickness of the cladding 18b in the light extraction region 30 is preferably thinner than a thickness of a region where light (evanescent light) leaks out from the core 18a of the optical fiber 18 to the cladding 18b.

It is known that when light propagates through media of different refractive indices, if an energy reflectance in total reflection is calculated, reflected light energy is equal to incoming light energy, and an evanescent wave slightly leaks on the opposite side of the boundary plane. Since the enter depth of the evanescent wave component is approximated on the order of π/2π (λ is a wavelength in the refractive index of the propagation region), the region where the evanescent wave leaks out from the core 18a to the cladding 18b is λ/2π from the outer periphery of the core 18a. Thus, the thickness of the cladding in the light extraction region 30 is preferably thinner than λ/2π.

The light extraction region 30 spreads along the axis of the optical fiber 18 for a range of a predetermined length. For example, the length of the light extraction region 30 along the axis of the optical fiber 18 is preferably as long as or longer than the incident aperture of the PD 36. If the opening is set at such a dimension, various modes of the light guided by the optical fiber 18 are emitted from the light extraction region 30; accordingly, less influence by the modes, compared to the case where only specific modes of light are emitted, allows improved stability in the detection of a quantity of light.

The diffusion member 32 is constituted from a number of diffusing elements consisting of transparent and high-refractive particles, such as alumina particles and SiO₂ particles, for example, bound together by a resin. In other words, the diffusion member 32 is constituted by a member in which a number of diffusion elements are diffused in a resin. The diffusion member 32 may be provided so as to fill the concave part formed as a result of forming the light extraction region 30. The surface of the diffusion member 32 may be bowed in a sphere shape. The resin binding a number of diffusing elements preferably has a refractive index halfway between the refractive index of the cladding 18b and the refractive index of air. Thus, the interface reflection between the cladding 18b and the diffusion member 32 is reduced, and the light extracted from the core 18a of the optical fiber 18 through the light extraction region 30 is guided to the PD 36 with less loss.

A reflector 34 is disposed around the space from the light extraction region 30 to the PD 36. The reflector 34 has a cylindrical shape and its inner surface is a mirror. The reflector 34 is not limited thereto; it may be a structure having a curved mirror that collects more light to the PD 36.

The diffusion member 32 and the reflector 34 constitute a detected light optimization section that changes detected light extracted from the optical fiber 18 by the light extraction region 30 into light having an optical characteristic appropriate for detection of a quantity of light performed by the PD 36.

### <Effects>

Light source light emitted from the light emitting element 14 in the light source 12 enters the core 18a of the optical fiber 18 through the lens 16. The light source light that has entered the core 18a propagates through repeated total reflection on the interface between the core 18a and the cladding 18b. A part of the light source light propagated in the core 18a passes through the light extraction region 30 and leaks out of the optical fiber 18 as detected light. The detected light that has passed through the light extraction region 30 and has leaked out enters the diffusion member 32 and diffused by the diffusion elements in the diffusion member 32, and the diffused light travels in different directions and a part of the light is emitted from the diffusion member 32. A part of the detected light emitted from the diffusion member 32 directly enters the PD 36, and another part of the detected light enters the PD 36 after being reflected by the mirror of the reflector 34.

In this structure, the detected light emitted outside of the optical fiber 18 is light that has leaked out through the light extraction region 30 through the core 18a, and has been diffused by the diffusion member 32. Thus, fluctuation in detection sensitivity and loss of detection stability due to the influence of a mode in the optical fiber 18 and/or the influence of the relative position relationship between the optical fiber 18 and the PD 36 can be prevented. Furthermore, since the detected light emitted from the diffusion member 32 is favorably directed to the PD 36 by the mirror of the reflector 34, the detection of a quantity of light is effectively performed. In other words, the detected light emitted from the optical fiber 18 is changed by the diffusion member 32 and the reflector 34 into light having an optical characteristic appropriate for the light detection by the PD 36.

As described above, stable detection of a quantity of light can be performed while suppressing the loss of light guided by the optical fiber 18.

A reflection film may be provided at the edge face of the cladding 18b that defines the light extraction region 30, in other words, the portion where light from the core 18a is not transmitted, including the inner periphery wall of the concave portion formed as a result of forming the light extraction region 30. Thus, the light leaking out of the light extraction region 30 is prevented from entering the cladding 18b of the optical fiber 18 to be lost.

An irregular shape with a dielectric multilayer film or a nano structure is formed on the surface of the diffusion member 32 facing the PD 36, i.e., an emission plane of the detected light, to reduce a reflection loss on the emission plane.

### Embodiment 2

### <Structure>

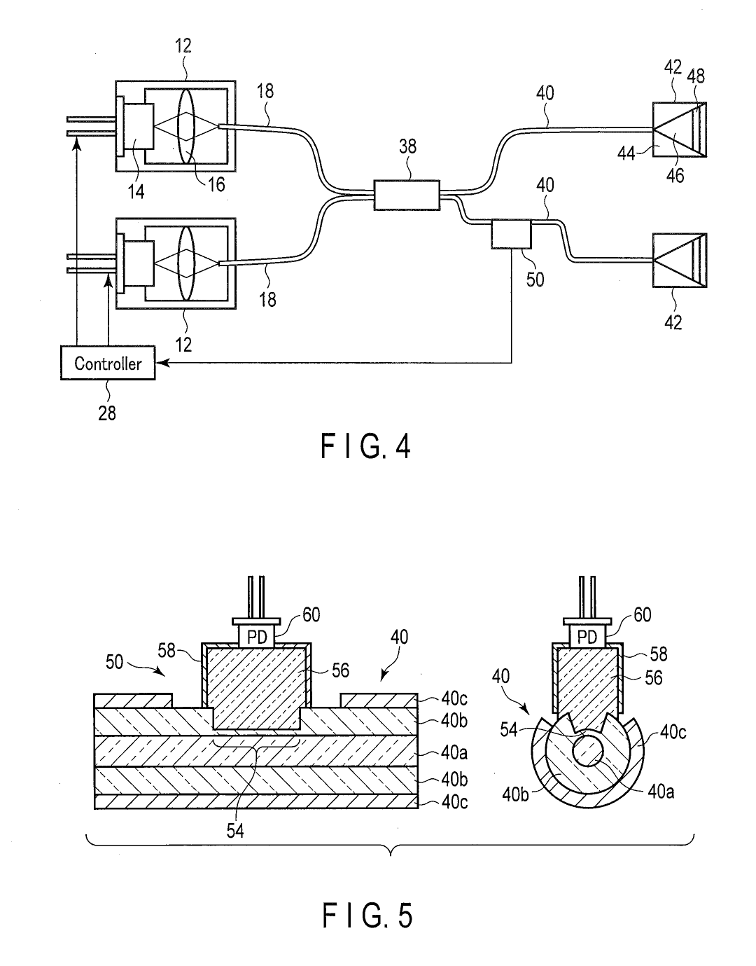

The structure of the light source apparatus according to the present embodiment is shown in FIG. 4. In the drawings, the members referred to by the same reference numbers as the members in Embodiment 1 are the same members.

The light source apparatus according to the present embodiment comprises two light sources 12, two optical fibers 18 that respectively guide light source light emitted from the two light sources 12, an optical coupler 38 that combines light guided by the two optical fibers 18, two optical fibers 40 that guide light combined by the optical coupler 38, two illumination units 42 respectively optically-coupled to the two optical fibers 40, and a light detection section 50 that detects a quantity of the light source light guided by one of the optical fibers 40.

The two light sources 12, the two optical fibers 18, and the illumination units 42 are substantially the same, respectively. The two optical fibers 40 are substantially the same, except that a light detection section 50 is provided at one of them. The basic structure of each of the optical fibers 40 may be the same as that of the optical fiber 18.

The light source apparatus also includes a controller 28 that controls two light emitting elements 14 in the two light sources 12 based on a detection signal output from the light detection section 50.

### <Optical Coupler>

The optical coupler 38 according to the present embodiment is a two-input two-output optical coupler having two input ends and two output ends. Such an optical coupler has a function of dividing light input from one of the two input ends at a predetermined division ratio and outputting the divided light from the two output ends. The division ratio of the optical coupler 38 in the present embodiment is 50:50, and the optical coupler 38 has a function of dividing the light source light input from one of the two input ends into an equal light quantity ratio and outputting the divided light from the two output ends.

The optical fibers 18 coupled to the light sources 12 are coupled to the input ends of the optical coupler 38, and the optical fibers 40 coupled to the illumination units 42 are coupled to the output ends of the optical coupler 38.

### <Illumination Unit>

Each illumination unit 42 includes a holding member 44 having a through hole in a shape of a circular truncated cone, and a phosphor 46 and a diffusion member 48 are arranged inside the through hole of the holding member 44. The optical fiber 40 is optically coupled at the opening on the small diameter side of the through hole in a shape of a circular truncated cone of the holding member 44. The optical fiber 40 is inserted into a ferrule (not shown) fixed to the holding member 44 and is held.

The phosphor 46 is a wavelength conversion member that absorbs primary light that is light source light emitted from the light source 12, and converts the primary light to have a longer peak wavelength, a broader spectrum shape, and a larger radiation angle. The phosphor 46 is made by mixing a powdery fluorescent material with a resin, glass, etc. having a property that transmits primary light and hardening the mixture. In the present embodiment, the fluorescent material of the phosphor 46 is composed of Ce-doped YAG (yttrium-aluminum-garnet) mixed with a transparent silicon resin. The thickness and concentration of the phosphor is adjusted so as to make the optical characteristic of the secondary light to be appropriately emitted as illumination light to illuminate an observation target.

The diffusion member 48 has a function of expanding a radiation angle of primary light, which is light source light emitted from the light source 12, without converting a peak wavelength and a spectrum shape of primary light. The diffusion member 48 is made by mixing, within a member that transmits primary light, a diffusion material having a refractive index different from that of the primary light-transmitting member, and curing the mixture. For example, the diffusion member 48 is constituted by mixing glass fillers having the refractive index of 1.5 in a resin having the refractive index of 1.4. The thickness and concentration of the diffusion member 48 is adjusted so that the radiation angle of the secondary light is appropriate as illumination light to illuminate an observation target.

### <Light Detection Section>

The light detection section 50 for detecting a quantity of the light source light guided by the optical fiber 40 is provided at one of the optical fibers 40 respectively connected to the two output ends of the optical coupler 38. The basic structure of the light detection section 50 is similar to that of the light detection section 20 of Embodiment 1.

A specific structure of the light detection section 50 is shown in FIG. 5. As shown in FIG. 5, a jacket (coating) 40c is provided around the cladding 40b of the optical fiber 40 to intensify the strength of the optical fiber 40. An opening is formed at a part of the jacket 40c, and the cladding 40b is partially exposed. A light extraction region 54 is formed at the exposed portion of the cladding 40b. The details of the light extraction region 54 may be similar to those of the light extraction region 30 of Embodiment 1.

A photodiode (PD) 60 serving as the light detector 26 is disposed facing the light extraction region 54. A diffusion member 56 is provided in the space between the light extraction region 54 of the optical fiber 40 and the PD 60. The diffusion member 56 is disposed so as to be in direct contact with a SiO₂ film formed on the surface of a photoreceptor of the PD 60. The details of the diffusion member 56 may be similar to those of the diffusion member 32 of Embodiment 1.

Furthermore, the exposed portion of the diffusion member 56 is covered by a reflector 58 in which the inner surface is a mirror. Accordingly, the diffusion member 56 is surrounded by the optical fiber 40, the PD 60, and the reflector 58.

### <Effects>

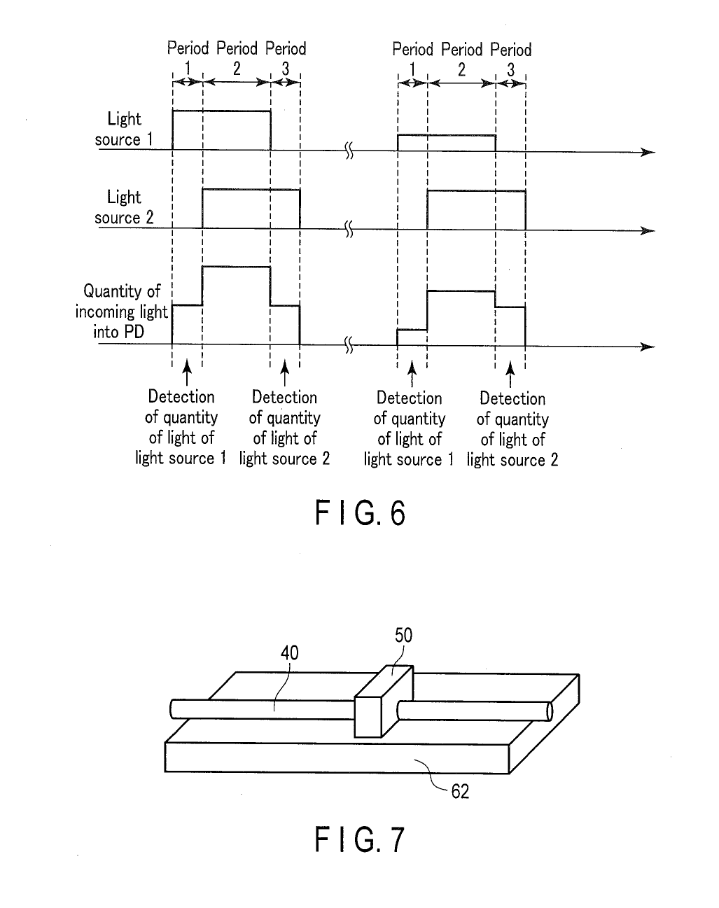

The lighting pattern example of the light source 12 in the light source apparatus of the present embodiment is shown in FIG. 6. In FIG. 6, one of the two light sources 12 is referenced as light source 1, and the other as light source 2. As shown in FIG. 6, only the light source 1 is lighted during the period 1, both of the light sources 1 and 2 are lighted during the period 2, and only the light source 2 is lighted during the period 3. In other words, the light sources 1 and 2 are lighted in accordance with the lighting patterns including a period during which both of the light sources are lighted, that is, the period 2, and periods during which one of the light sources are lighted, that is, the periods 1 and 3. The left side of FIG. 6 shows an example in which both of the light sources 1 and 2 are lighted at the same output. It is not necessary to light the light sources 1 and 2 at the same output; they may be lighted at different outputs. The right side of FIG. 6 shows an example in which the light sources 1 and 2 are lighted at different outputs.

A quantity of output light from the light source 1 can be detected by detecting a quantity of incoming light into the PD 60 during the period 1; a quantity of output light from the light source 2 can be detected by detecting the quantity of incoming light into the PD 60 during the period 3; and a total quantity of output light from the light sources 1 and 2 can be detected by detecting a quantity of incoming light into the PD 60 during the period 2.

In the present embodiment, since the light detection section 50 is provided at the optical fiber 40 connected to the output end of the optical coupler 38, the mode of the light source light passing the light detection section 50 is made uniform by the optical coupler 38. For this reason, the detection of a quantity of light at the light detection section 50 is less susceptible to a mode change at the light source 12.

In the present embodiment, a two-input two-output type coupler is described as an example of the optical coupler 38, but the embodiment is not limited thereto; other types, for example, a two-input one-output type coupler may be adopted.

The light detection 50 is, of course, provided at one optical fiber connected to one output end.

As shown in FIG. 7, preferably, the light detection section 50, together with the adjacent optical fiber 40, may also be fixed to a fixation member 62, which does not easily deform. Fixing the light detection section 50 and the adjacent optical fiber 40 to the same fixation member 62 prevents deformation of the light extraction region 54. As a result, the relationship between the light source light guided by the optical fiber 40 and the light detected by the PD 60 as a light detector, i.e., the detection sensitivity, is maintained constant, so that the detection can be more stably performed.

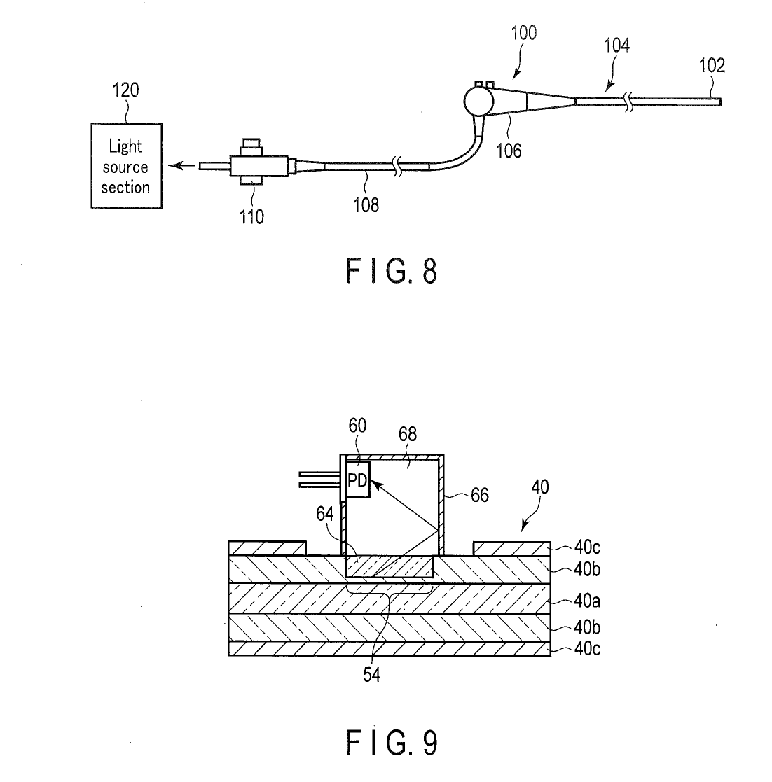

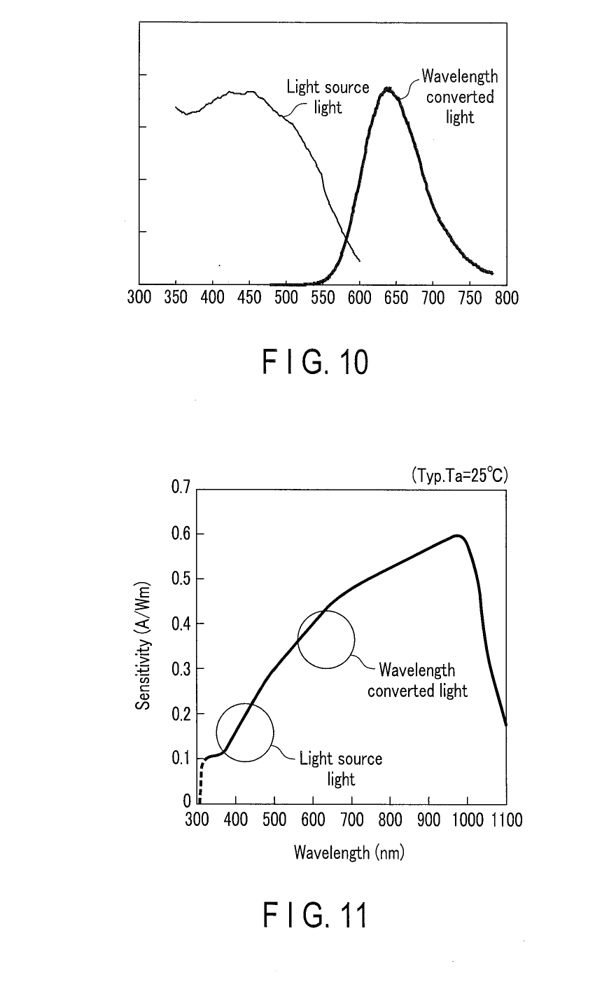

Regardless of the present embodiment, the light source apparatus of each of the embodiments may be mounted in the endoscope apparatus. FIG. 8 schematically shows an endoscope apparatus to which the light source apparatus of the present embodiment as a representative is mounted. As shown in FIG. 8, the endoscope apparatus 100 includes an insertion section 104 having a distal end portion 102 to be inserted into an observation space, and an operation section 106 that holds the insertion section 104, the operation section 106 being provided with various elements for operation. A universal cord 108 is connected to the operation section 106, and to the light source section 120 through the connection section 110 provided at the edge portion of the universal cord 108.

The light source 12 of the light source apparatus is provided within the light source section 120, and the illumination unit 42 is provided at the distal end portion 102 of the insertion section 104 of the endoscope apparatus 100. For example, the optical fiber/s 18, the optical coupler 38, and the optical fiber/s 40 are extended inside the endoscope apparatus 100, and the light detection section 50 is fixed to a non-deformable portion of the endoscope apparatus 100, for example. In other words, the fixation member that fixes the light detection section 50 may be anon-deformable portion, such as a case, etc., in the endoscope apparatus 100. Such a non-deformable portion may be located inside of any of the operation section 106, the insertion section 104, and the distal end portion 102.

The light detection section 50 may be disposed inside the light source section 120 with the optical coupler 38 and fixed to a member in the light source section 120. In other words, the fixation member that fixes the light detection section 50 is a member, such as a case, etc. in the light source section 120.

### Modification 1 of Embodiment 2

Another structure example of the light detection section 50 is shown in FIG. 9. In this structure example, a diffusion member 64 is provided at a concave portion formed as a result of forming the light extraction region 54, and a reflector 66 is disposed in the direction in which detected light leaks out strongly from the light extraction region 54 through the light extraction region 54. The reflector 66 reflects detected light leaking out from the light extraction region 54 toward the PD 60. The diffusion member 64 diffuses detected light leaking out through the diffusion member 64 to the extent that an error in detection of a quantity of light due to an error in the arrangement of the PD 60 can be suppressed. The space 68 between the diffusion member 64 and the PD 60 may be filled with the air or with a transparent resin.

### Modification 2 of Embodiment 2

### <Structure>

In the present structure example, the light source 12 emits light with a relatively short wavelength. For example, the light source 12 emits purple light at a wavelength near 400 nm, or blue light at the wavelength near 450 nm. The diffusion member 56 is replaced with a wavelength conversion member. The wavelength conversion member is constituted by, for example, what particles or powder of a phosphor, which are a number of wavelength conversion elements, are bound by a resin. In other words, the wavelength conversion member constituted by a member in which a number of wavelength conversion elements are diffused in a resin. In the wavelength conversion member, a number of diffusion elements may be diffused, in addition to a number of wavelength conversion elements.

The phosphor absorbs light source light of a relatively short wavelength and isotropically emits fluorescent light having a longer wavelength than the light source light. In other words, the phosphor converts light source light of a short wavelength into wavelength-converted light with a long wavelength.

In the PD 60, the sensitivity in the wavelength of the wavelength-converted light is higher than the sensitivity in the wavelength of the light source light, as shown in FIG. 11. Preferably, the sensitivity of the PD 60 to the wavelength-converted light is more than twice as high as the sensitivity to the light source light.

### <Effects>

A part of light source light (400 nm to 450 nm) guided by the optical fiber 40 is extracted as detected light by the light extraction region 54 and enters the wavelength converting member. A part of the detected light is wavelength-converted into red fluorescent light (600 nm to 650 nm). A part of the wavelength-converted fluorescent light enters the PD 60 and is detected.

Thus, in the present modification, the detected light extracted by the light extraction region 54 is converted into red fluorescent wavelength-converted light and detected. Since the PD 60 has a higher sensitivity in the wavelength range of the wavelength-converted light than the wavelength range of the light source light, the detected light can be detected with a high sensitivity in comparison to the case where the detected light is directly detected. Accordingly, the detection of a quantity of light is less susceptible to noise, etc., so that the detection can be more stably performed.

### Embodiment 3

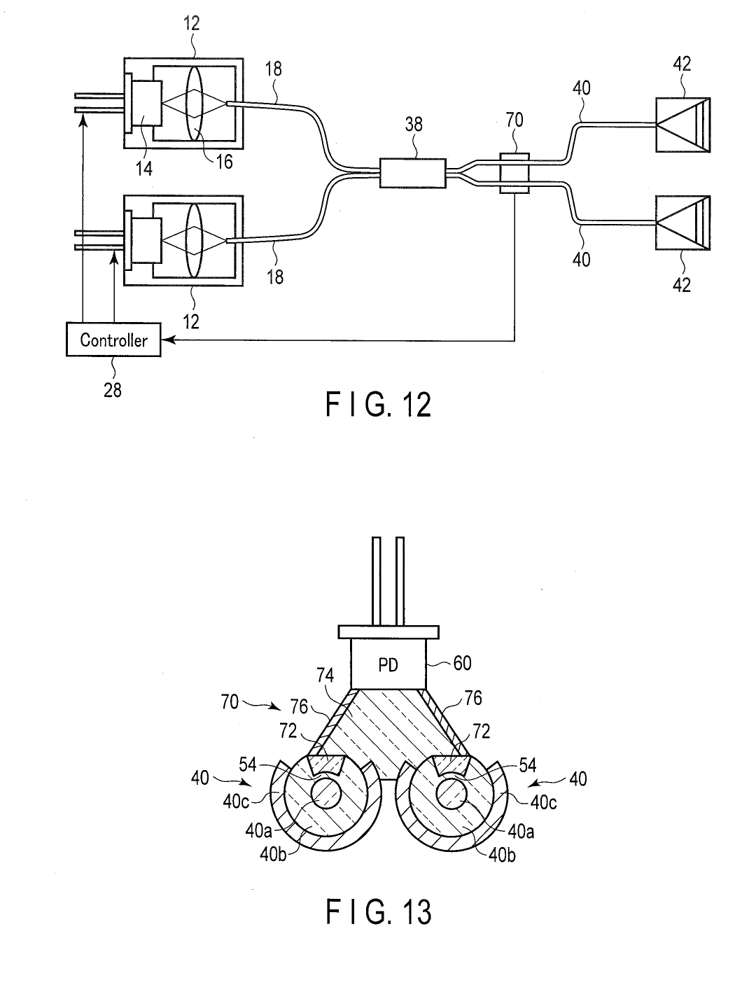

The structure of the light source apparatus according to the present embodiment is shown in FIG. 12. In the drawings, the members referred to by the same reference numbers as the members in Embodiments 1 and 2 are the same members.

The light source apparatus of the present embodiment is similar to the light source apparatus of embodiment 2, but it is different from the light source apparatus of the embodiment 2 in that a light detection section 70 that detects a quantity of the light source light guided by the two optical fibers 40 is provided in place of the light detection section 50 that detects a quantity of the light source light guided by one of the optical fibers 40.

A specific structure of the light detection section 70 is shown in FIG. 13. As shown in FIG. 13, the light extraction region 54 is provided at each of the two optical fibers 40, and a diffusion member 72 is provided at the concave portion formed as a result of the forming of the light extraction region 54. Light emitting planes of the two diffusion members 72 are arranged parallel to a light-receptive plane of the PD 60. Another diffusion member 74 is provided in the space between the two diffusion members 72 and the PD 60. A reflector 76 in which the inner surface is a mirror is provided around the diffusion member 74. The details of the diffusion members 72 and 74 may be similar to those of the diffusion member 32 of Embodiment 1.

The detected light extracted from each of the optical fibers 40 by the light extraction region 54 and passed through the diffusion member 72 enters in common to the PD 60 through the diffusion member 74 and the reflector 76.

In the present embodiment, since the light extraction regions 54 are provided at both of the two optical fibers 40, the sensitivity of the detection of a quantity of light by the PD 60 is improved. The detection of a quantity of light is not influenced by a change of the division ratio of the optical coupler 38 over time.

### Modification of Embodiment 3

The two light sources 12 emit light source light of different wavelengths, respectively. The diffusion members 72 of the two optical fibers 40 are respectively replaced with wavelength conversion members having different wavelength conversion characteristics respectively corresponding to light source light of different wavelengths emitted from the two light sources 12. The wavelength conversion members of the two optical fibers 40 effectively convert the wavelength of the light source light emitted from the two light sources 12, respectively. Preferably, the wavelength conversion member of one of the optical fibers 40 effectively converts the wavelength of the light source light emitted from one of the light sources 12, but does not convert the wavelength of the light source light emitted from the other light source 12, and vice versa. The PD 60 preferably has a low detection sensitivity for the light source light emitted from the two light sources 12, but has a high detection sensitivity for wavelength-converted light generated by the wavelength conversion member of the two optical fibers 40. In other words, the light emitting element 14 of the light source 12, the material of the wavelength conversion member, and the PD 60 are selected to favorably satisfy these requirements.

Such a configuration allows a quantity of the light source light emitted from the two light sources 12 to be separated and detected, using a single light detection section 70.

The embodiments of the present invention have been described with reference to the drawings as in the foregoing; however, the present invention is not limited to those embodiments, and various modifications and changes maybe made to some extent that does not deviate from the scope of the embodiments. The modifications and changes mentioned herein include an implementation achieved by combining the above-described embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A light source apparatus, comprising:
at least one light source;
at least one optical fiber that guides light source light emitted from the light source; and
a light detection section that detects a quantity of the light source light guided by the optical fiber;
the light detection section comprising:
a light detector that outputs a signal indicating a quantity of incoming light;
a light extraction section that is provided at a part of the optical fiber and extracts a part of light source light guided by the optical fiber as detected light; and
a detected light optimization section that changes the detected light extracted from the optical fiber by the light extraction section into light having a light characteristic appropriate for detection of a quantity of light by the light detector.

2. The light source apparatus according to claim 1, wherein
the optical fiber includes a core and a cladding,
the light extraction section comprises a region of part of the cladding where a thickness of the cladding is locally reduced, and the thickness of the cladding in the region is adjusted so as to allow a minimum quantity of the light source light required for detection of a quantity of light by the light detector to leak out.

3. The light source apparatus according to claim 2, wherein the cladding in the region has a thickness equal to or less than λ/2π where A is a wavelength of the light source light.

4. The light source apparatus according to claim 2, wherein the detected light optimization section includes diffusion elements or wavelength conversion elements arranged in the region.

5. The light source apparatus according to claim 4, wherein the diffusion elements or the wavelength conversion elements is diffused in a resin, and a refractive index of the resin is equal to or higher than a refractive index of the cladding.

6. The light source apparatus according to claim 4, wherein the detected light optimization section includes a reflector disposed to surround a space from the region to the light detector.

7. The light source apparatus according to claim 4, wherein the detected light optimization section further includes a reflector that reflects detected light leaking out from the region toward the light detector, the reflection member being disposed in a direction in which detected light more strongly leaks out from the region.

8. The light source apparatus according to claim 1, wherein
the at least one light source includes a plurality of light sources,
the light source apparatus further comprises an optical coupler that combines light source light emitted from the plurality of light sources,
the at least one optical fiber includes a plurality of optical fibers, and the plurality of optical fibers includes a plurality of input-side optical fibers that respectively guide light source light from the plurality of light sources to the optical coupler and at least one output-side optical fiber that guides combined light from the optical coupler, and
the light detection section is applied to the at least one output-side optical fiber.

9. The light source apparatus according to claim 8, wherein the plurality of light sources are lighted in accordance with a lighting pattern including a plurality of periods during which the plurality of light sources are individually lighted.

10. The light source apparatus according to claim 8, wherein the plurality of light sources respectively emit light source light of a plurality of different wavelengths, and the detected light optimization section includes a plurality of wavelength conversion members having different wavelength conversion characteristics respectively corresponding to the plurality of wavelengths of the light source light.

11. The light source apparatus according to claim 8, wherein the optical coupler has a function of dividing combined light into a plurality of outputs and outputting the divided combined light, the at least one output-side optical fiber includes a plurality of output-side optical fibers, the light extraction section is provided at each of the plurality of output-side optical fibers, and detected light extracted from the plurality of output-side optical fibers by the light extraction section enters the light detector through the detected light optimization section.

12. The light source apparatus according to claim 1, further comprising a fixation member that prevents deformation of the light extraction section.

13. An endoscope apparatus comprising the light source apparatus of claim 1, wherein the light extraction section is fixed to a non-deformable portion of the endoscope apparatus.
